(19) United States
(12) Patent Application Publication
(10) Pub. No.: US 2017/0171269 A1
(43) Pub. Date: Jun. 15, 2017

(54) MEDIA CONTENT PLAYBACK METHOD, APPARATUS AND SYSTEM

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Weibo AO, Beijing (CN)

(73) Assignees: LE HOLDINGS (BEIJING) CO., LTD., Beijing (CN); LE SHI INTERNET INFORMATION & TECHNOLOGY CORP., BE IJING, Beijing (CN)

(21) Appl. No.: 15/243,485

(22) Filed: Aug. 22, 2016

Related U.S. Application Data
(63) Continuation of application No. PCT/CN2016/089551, filed on Jul. 10, 2016.

(30) Foreign Application Priority Data
Dec. 10, 2015 (CN) 201510918550.6

(51) Int. Cl. H04L 29/06; H04L 29/08

(52) U.S. Cl. CPC H04L 65/4084; H04L 65/60; H04L 67/42; H04L 67/10

(57) ABSTRACT

Embodiments of the present disclosure provide a method and an electronic device for playing media content. The method includes: when a smart television plays a television program received from a broadcast television network, collecting data of the currently played television program, and uploading the data to a server; and receiving media content that matches the currently played television program and that is sent by the server according to the data, and playing the media content.

### CROSS-REFERENCE TO RELATED APPLICATION

The present disclosure is a continuation of PCT application No. PCT/CN2016/089551PCT submitted on Jul. 10, 2016. The present disclosure claims priority to Chinese Patent Application No. 201510918550.6, filed with the Chinese Patent Office on Dec. 10, 2015, which is incorporated herein by reference in its entirety.

### TECHNICAL FIELD

Embodiments of the present disclosure relate to information processing technologies, and in particular, to a method and an electronic device for playing media content.

### BACKGROUND

At present, when using a smart television to play video media content, a user actively chooses to watch a television program by using a broadcast television network or by using a media resource library on a server for the smart television.

When the user watches a television program by using the broadcast television network, the user may not know that there are more abundant media resources in the media resource library on the server; or when the user watches a television program by using the broadcast television network, the user blindly switches to the media resource library on the server to find whether there is a same media resource, but fails to find the media resource. The occurrence of the foregoing cases is mainly due to that the smart television fails to make good use of the media resource library of the server side to provide media resources to the user at an appropriate time, resulting in that the user encounters the foregoing problems when viewing the television program.

### SUMMARY

Embodiments of the present disclosure provide a method and an electronic device for playing media content, so as to actively provide media content to a user at an appropriate time by means of a server of a smart television, thereby improving experience of the user in viewing the media content.

To implement the objectives, an embodiment of the present disclosure provides a method for playing media content, including: when a smart television plays a television program received from a broadcast television network, collecting data of the currently played television program, and uploading the data to a server; and receiving media content that matches the currently played television program and that is sent by the server according to the data, and playing the media content.

An embodiment of the present disclosure further provides another method for playing media content, including: receiving data of a currently played television program sent by a smart television received from a broadcast television network; and selecting media content matching the currently played television program from a local media library, and sending the media content to the smart television, so that the smart television plays the media content.

An embodiment of this disclosure further provides a non-volatile computer storage medium, which stores computer executable instructions, where the computer executable instructions are used to execute any foregoing method for playing media content of this disclosure.

An embodiment of this disclosure further provides an electronic device, including: at least one processor; and memory for storing instructions executable by the at least one processor, where execution of the instructions by the at least one processor causes the at least one processor to execute any foregoing method for playing media content of this disclosure.

### BRIEF DESCRIPTION OF THE DRAWINGS

One or more embodiments are exemplarily described by using figures that are corresponding thereto in the accompanying drawings; the exemplary descriptions do not form a limitation to the embodiments. Elements with same reference signs in the accompanying drawings are similar elements. Unless otherwise particularly stated, the figures in the accompanying drawings do not form a scale limitation.

FIG. 1 is a flowchart of an embodiment of a method for playing media content according to an embodiment of the present disclosure;

FIG. 2 is a flowchart of another embodiment of a method for playing media content according to an embodiment of the present disclosure;

FIG. 3 is a schematic structural diagram of an embodiment of a terminal device according to an embodiment of the present disclosure;

FIG. 4 is a schematic structural diagram of another embodiment of a terminal device according to an embodiment of the present disclosure;

FIG. 5 is a schematic structural diagram of an embodiment of a server device according to an embodiment of the present disclosure;

FIG. 6 is a schematic structural diagram of another embodiment of a server device according to an embodiment of the present disclosure; and

FIG. 7 is a schematic structural diagram of hardware of an electronic device for executing a method for playing media content according to an embodiment of this disclosure.

### DETAILED DESCRIPTION

Basic conceptions of embodiments of the present disclosure are: collecting data of a broadcast television program currently played by a smart television, and uploading the data to a back-end server; and selecting, by the server, media content corresponding to the currently played television program from a local media library, and providing the media content to the smart television for playing, thereby satisfying a potential requirement of a user for watching media content.

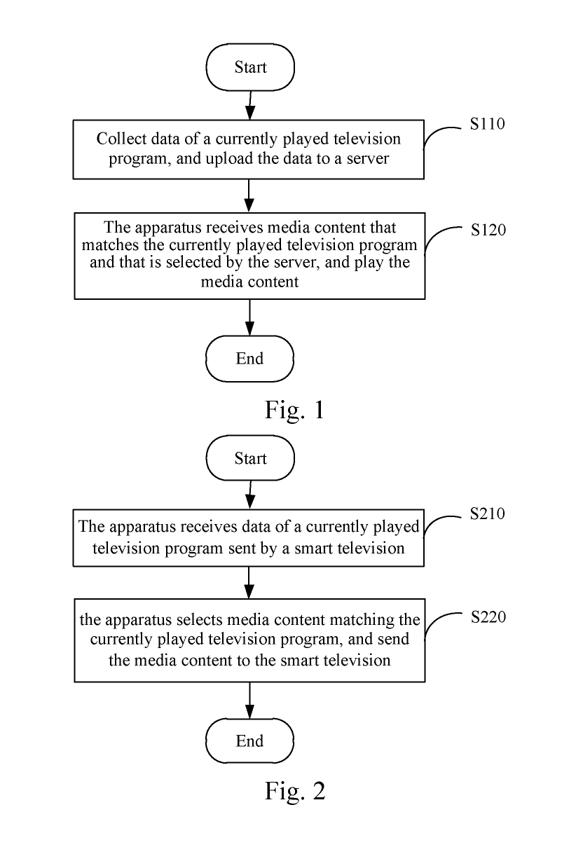

FIG. 1 is a flowchart of an embodiment of a method for playing media content according to an embodiment of the present disclosure. The method may be executed by a smart television or a terminal device integrated on or connected to a smart television.

Referring to FIG. 1, in step S110, When a smart television plays a television program received from a broadcast television network, collect data of the currently played television program, and upload the data to a server.

Generally, when using a smart television to watch a media program, a user actively chooses to watch a television program by using a broadcast television network (for example, using Gehua Wire) or by using a media resource library on a server for the smart television. When the user watches the television program by using the broadcast television network, and the smart television also enables a service connection to a back-end server, the data of the currently played television program may be collected in real time by a data acquisition device integrated on the smart television. The data of the television program may be station information, information of the television program (for example, title, play time, content outline of the television program) obtained by the smart television when the smart television receives a data flow of the television program through broadcast network, or may be data of a screen image of the television program collected in a process in which the smart television plays the television program. In an embodiment, the data of the television program in this solution mainly includes: the station information and/or the image data of the television program.

In step S120, the apparatus receives media content that matches the currently played television program and that is sent by the server according to the data of the currently played television program, and play the media content.

After receiving the data of the currently played television program, the server selects the media content matching the television program from a local media library on the server, and sends the media content to the smart television.

Specifically, the media content selected by the server may be same as or similar in content to the media content of the currently played television program. Specific selection methods and content and types of the selected media content may refer to content of a corresponding method in an embodiment as shown in FIG. 2, which is executed by the server. This embodiment merely describes the smart television, that is, a forward end.

After receiving the media content sent by the server, the smart television plays the media content, and at the same time, the smart television switches a mode in which the television program is watched currently receiving the data of the television program from the broadcast television network to the media library on the server.

In an embodiment, to respect a watching habit of the user, the user is not forced to switch the mode in which the television program is watched currently. After the server selects the media content matching the television program currently watched by the user, the server may first send a request for playing the media content to the smart television, and wait an instruction of whether to send the media content to the smart television.

After the smart television receives the request, the smart television presents the request for playing on an image playing interface, and the user determines whether to play the media content provided by the server. Specifically, when the television program watched by the user is an episode of a TV series A, and the media content selected by the server is other episodes of the TV series A, the request for playing displayed in the corresponding image playing interface may be: “More attractive content of the TV series A is all in here □”. □ may be a link operation key for requesting the server to send the media content. When the user operates the operation key by using a remote control or a touch operation (for example, a touchscreen of the smart television), that is, after sending an operation of allowing playing the media content to the server, the smart television receives the media content sent by the server, and controls play of the media content.

The method for playing media content provided by this embodiment of the present disclosure is, using a terminal device (front-end device) of a smart television as a subject of executing. By means of collecting data of a currently played television program from a broadcast television network, and uploading the data to a server; and play media content matching the television program obtained from the server, to improve experience of a user in watching the television program.

In an embodiment, before playing the media content provided by the server, the smart television may further display information of the request for playing by using the image playing interface according to the media content, to inquiry the user whether to watch the media content, and the user provides a corresponding indicative operation, thereby providing the user a more individualized selective operation.

FIG. 2 is a method flowchart of another embodiment for playing media content provided by an implementation manner of the present disclosure. An executing subject of this method may be a server that corresponding to the terminal device integrated on/connected to the smart television in FIG. 1.

Referring to FIG. Ian step S210, the apparatus receives data of a currently played television program sent by a smart television received from a broadcast television network.

Generally, when using a smart television to watch a media program, a user actively chooses to watch a television program by using a broadcast television network (for example, using Gehua Wire) or by using a media resource library on a server for the smart television. When the user watches a television program by using the broadcast television network, and the smart television also enables a service connection to a back-end server, the data of the currently played television program may be collected real time by a device, such as a data acquisition device integrated on the smart television. The data of the television program may be station information, information of the television program obtained by the smart television when the smart television receives a data flow of the television program through broadcast network, or may be data of a screen image of the television program collected in a process in which the smart television plays the television program. In an embodiment, the data of the television program in this solution mainly includes: the station information and/or the image data of the television program.

In step S220, the apparatus selects media content matching the currently played television program from a local media library, and send the media content to the smart television, so that the smart television plays the media content.

After receiving the data of the currently played television program, the server selects the media content matching the television program from the local media library on the server, and sends the media content to the smart television.

Specifically, the media content selected by the server may be same as or similar in content to the media content of the currently played television program. Specific selection methods and content and types of the selected media content are not limited. On the basis of that the data of the currently played television program is the station information and/or the image data of the current television program, the following provides a specific implementation manner for selecting the media content.

First, the station information and/or the image data of the currently played television program are parsed to identify content of the currently played television program.

For example, a schedule of the television program of a station may be learned according to the station information, so that a television program played at the current time is obtained. For another example, to identify image date according to the image data of the currently played television program, and in particular on a station icon of the image at the top left corner, so that the station on which the television program is played at the current time is obtained, and then the television program played at the current time may be obtained according to the schedule of the television program of the station. For another example, image content is collected directly from the image data, for example, character identification is performed on an actor in the television program, so that the content of the currently played television program is determined by querying all television programs acted by the actor.

Second, media content, same as or similar in content to the currently played television program is selected as the media content matching the currently played television program, from the local media library.

For example, when the television program watched by the user is an episode of a TV series A, other episodes of the TV series A may be selected as the media content pushed to the smart television. For another example, when it is identified that an actor B acts in the current television program, other television programs acted by the actor B may be selected as the media content pushed to the smart television.

In an embodiment, to respect a watching habit of the user, the user is not forced to switch the mode in which the television program is watched currently. After the server selects media content matching the television program currently watched by the user, the server may first send a request for playing the media content matching the currently played television program to the smart television, and wait an instruction of whether to send the media content to the smart television.

After the smart television receives the request, information of the request for playing may be presented on an image playing interface, and the user determines whether to play the media content provided by the server. Specific content that presents the request for playing may be referred to the corresponding content in FIG. 1. After the user controls the smart television sending an operation of receiving the media content to the server by using a remote control or a touch operation (for example, a touchscreen of the smart television), the server sends the media content to the smart television, so that the smart television plays the media content.

The method for playing media content provided by this embodiment of the present disclosure is, using a server device (back-end device) of a smart television as a subject of executing. By means of receiving data of a currently played television program from a broadcast television network; and selecting media content, matching the television program, from a local media library on the server, and sending the media content to the smart television for playing, to improve experience of a user in watching the television program.

In an embodiment, before sending the media content to the smart television, the server first sends the request for playing the media content to the smart television, to inquiry the user whether to watch the media content by using the smart television, and the user provides a corresponding indicative operation, thereby providing the user a more individualized selective operation.

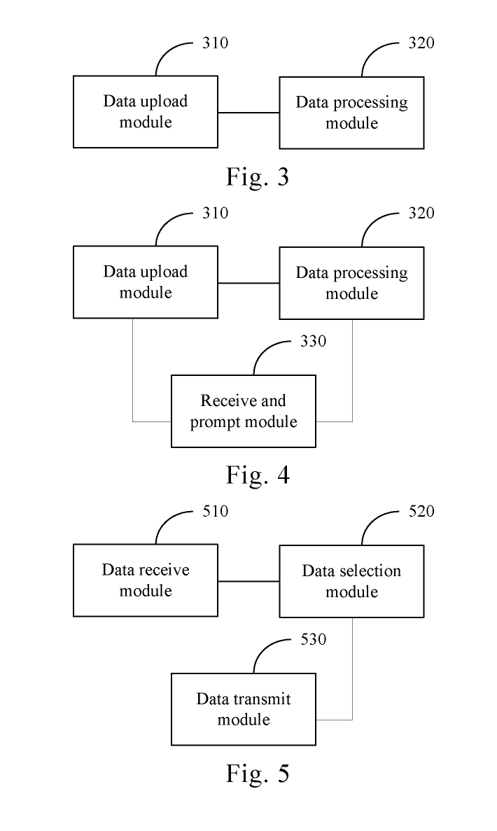

FIG. 3 is a schematic structural diagram of an embodiment of a terminal device according to an embodiment of the present disclosure, and the device may be used to implement the steps of the method as shown in FIG. 1.

Referring to FIG. 3, the terminal device specifically includes: a data upload module 310 and a data processing module 320.

The data upload module 310 is configured to: when a smart television plays a television program received from a broadcast television network, collect data of the currently played television program, and upload the data to a server; and the data processing module 320 is configured to: receive media content that matches the currently played television program and that is sent by the server according to the data, and play the media content.

According to the terminal device provided by this embodiment of the present disclosure, by means of collecting the data of the currently played television program from the broadcast television network, and uploading the data to the server, the server obtains media content matching the television program and plays the media content, to improve experience of a user in watching the television program.

On this basis, as shown in FIG. 4, the terminal device may further include: a receive and prompt module 330, configured to receive a request sent by the server for playing the media content, and present the request by using the smart television; and the data processing module 320, further configured to: receive the media content that matches the currently played television program and that is sent by the server according to the data, in response to an operation triggered by a user according to the request to allow playing the media content.

In an embodiment, the data of the currently played television program includes: station information and/or image data of the currently played television program.

In this solution, before playing the media content provided by the server, the smart television may further display information of the request for playing by using the image playing interface according to the media content, to inquiry the user whether to watch the media content, and the user provides a corresponding indicative operation, thereby providing the user a more individualized selective operation.

FIG. 5 is a schematic structural diagram of an embodiment of a server device according to an embodiment of the present disclosure, and the device may be used to implement the steps of the method as shown in FIG. 2.

Referring to FIG. 5, the server device specifically includes: a data receive module 510, a data selection module 520, and a data transmit module 530.

The data receive module 510 is configured to receive data of a currently played television program sent by a smart television received from a broadcast television network; the data selection module 520 is configured to select media content, matching the currently played television program, from a local media library; and the data transmit module 530 is configured to send the media content to the smart television, so that the smart television plays the media content.

According to the server device provided by this embodiment of the present disclosure, by means of receiving data of a currently played television program from a broadcast television network; and selecting media content matching the television program from a local media library on the server, and sending the media content to the smart television for playing, to improve experience of a user in watching the television program.

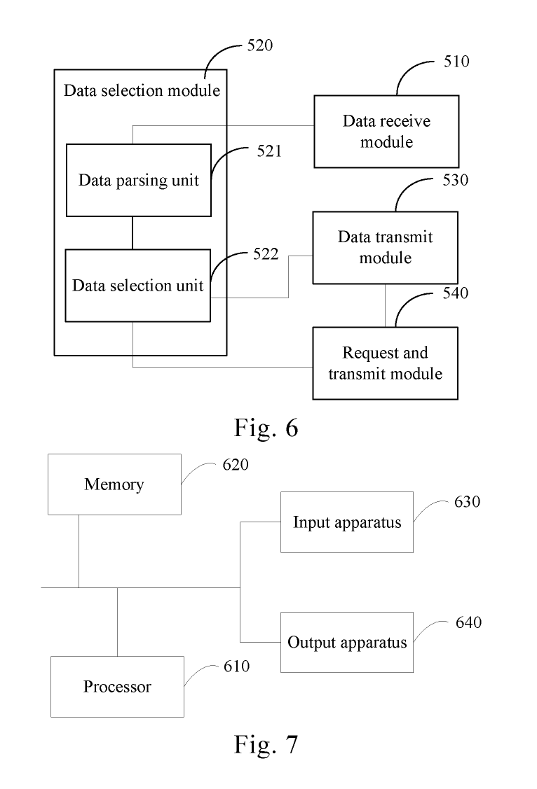

On this basis, as shown in FIG. 6, the server device may further include: a request and transmit module 540, configured to: after the media content matching the currently played television program is selected from the local media library, send a request for playing the media content to the smart television; and the data transmit module 530, further configured to: send the media content to the smart television, in response to an operation of the smart television for requesting to receive the media content, so that the smart television plays the media content.

In an embodiment, the data of the currently played television program includes: station information and/or image data of the currently played television program.

On this basis, the data selection module 520 may include: a data parsing unit 521, configured to parse the station information and/or the image data of the currently played television program to identify content of the currently played television program; and a data selection unit 522, configured to select media content same as or similar in content to the currently played television program as the media content matching the currently played television program from the local media library.

In this solution, before sending the media content to the smart television, the server sends the request for playing the media content to the smart television first, to inquiry the user whether to watch the media content by using the smart television, and the user provides a corresponding indicative operation, thereby providing the user a more individualized selective operation.

On this basis, an embodiment of the present disclosure further provides a system for playing media content, including: the terminal device in FIG. 3 or FIG. 4, and the server device in FIG. 5 or FIG. 6, where the terminal device is connected to the server device.

Specifically, the terminal device is configured to: when a smart television plays a television program received from a broadcast television network, collect data of the currently played television program, and upload the data to a server; and receive media content that matches the currently played television program and that is sent by the server according to the data, and play the media content.

The server device is configured to: receive data of a currently played television program sent by a smart television received from a broadcast television network; and select media content, matching the currently played television program, from a local media library, and send the media content to the smart television, so that the smart television plays the media content.

The system for playing media content provided by the implementation manners of the present disclosure actively provides media content to a user at an appropriate time by means of a server of a smart television, thereby improving experience of the user in watching the media content.

An embodiment of this disclosure provides a non-volatile computer storage medium, which stores computer executable instructions, where the computer executable instructions can execute the method for playing media content in any one of the foregoing method embodiments.

FIG. 7 is a schematic structural diagram of hardware of an electronic device for executing the method for playing media content according to embodiments of this disclosure. As shown in FIG. 7, the device includes: one or more processors 610 and a memory 620, where only one processor 610 is used as an example in FIG. 7.

An electronic device for executing the method for playing media content may further include: an input apparatus 630 and an output apparatus 640.

The processor 610, the memory 620, the input apparatus 630, and the output apparatus 640 can be connected by means of a bus or in other manners. A connection by means of a bus is used as an example in FIG. 6.

As a non-volatile computer readable storage medium, the memory 620 can be used to store non-volatile software programs, non-volatile computer executable programs and modules, for example, program instructions/module corresponding to the method for playing media content in the embodiments of this disclosure (for example, the data upload module 310, the data processing module 320 shown in FIG. 3 and the data receive module 510, the data selection module 520, and the data transmit module 530 shown in FIG. 5). The processor 610 executes various functional applications and data processing of the server, that is, implements the method for playing media content of the foregoing method embodiments, by running the non-volatile software programs, instructions, and modules that are stored in the memory 620.

The memory 620 may include a program storage area and a data storage area, where the program storage area may store an operating system and an application that is needed by at least one function; the data storage area may store data created according to use of the device for executing the method for playing media content, and the like. In addition, the memory 620 may include a high-speed random access memory, or may also include a non-volatile memory such as at least one disk storage device, flash storage device, or another non-volatile solid-state storage device. In some embodiments, the memory 620 optionally includes memories that are remotely disposed with respect to the processor 610, and the remote memories may be connected, via a network, to the electronic device for executing the method for playing media content. Examples of the foregoing network include but are not limited to: the Internet, an intranet, a local area network, a mobile communications network, or a combination thereof.

The input apparatus 630 can receive entered digits or character information, and generate key signal inputs relevant to user setting and functional control of the server. The output apparatus 640 may include a display device, for example, a display screen.

The one or more modules are stored in the memory 620; when the one or more modules are executed by the one or more processors 610, the method for playing media content in any one of the foregoing method embodiments is executed.

The foregoing product can execute the method provided in the embodiments of this disclosure, and has corresponding functional modules for executing the method and beneficial effects. Refer to the method provided in the embodiments of this disclosure for technical details that are not described in detail in this embodiment.

The electronic device in this embodiment of this disclosure exists in multiple forms, including but not limited to:

(1) Mobile communication device: such devices are characterized by having a mobile communication function, and primarily providing voice and data communications; terminals of this type include: a smart phone (for example, an iPhone), a multimedia mobile phone, a feature phone, a low-end mobile phone, and the like;

(2) Ultra mobile personal computer device: such devices are essentially personal computers, which have computing and processing functions, and generally have the function of mobile Internet access; terminals of this type include: PDA, MID and UMPC devices, and the like, for example, an iPad;

(3) Portable entertainment device: such devices can display and play multimedia content; devices of this type include: an audio and video player (for example, an iPod), a handheld game console, an e-book, an intelligent toy and a portable vehicle-mounted navigation device;

(4) Server: a device that provides a computing service; a server includes a processor, a hard disk, a memory, a system bus, and the like; an architecture of a server is similar to a universal computer architecture. However, because a server needs to provide highly reliable services, requirements for the server are high in aspects of the processing capability, stability, reliability, security, extensibility, and manageability; and

(5) other electronic apparatuses having a data interaction function.

The apparatus embodiment is merely exemplary, and units described as separated components may be or may not be physically separated; components presented as units may be or may not be physical units, that is, the components may be located in a same place, or may be also distributed on multiple network units. Some or all modules therein may be selected according to an actual requirement to achieve the objective of the solution of this embodiment.

Through description of the foregoing implementation manners, a person skilled in the art can clearly learn that each implementation manner can be implemented by means of software in combination with a universal hardware platform, and certainly, can be also implemented by using hardware. Based on such understanding, the essence, or in other words, a part that makes contributions to relevant technologies, of the foregoing technical solutions can be embodied in the form of a software product. The computer software product may be stored in a computer readable storage medium, for example, a ROM/RAM, a magnetic disk, or a compact disc, including several instructions for enabling a computer device (which may be a personal computer, a sever, or a network device, and the like) to execute the method in the embodiments or in some parts of the embodiments.

Finally, it should be noted that: the foregoing embodiments are only used to describe the technical solutions of this disclosure, rather than limit this disclosure. Although this disclosure is described in detail with reference to the foregoing embodiments, a person of ordinary skill in the art should understand that he/she can still modify technical solutions disclosed in the foregoing embodiments, or make equivalent replacements to some technical features therein; however, the modifications or replacements do not make the essence of corresponding technical solutions depart from the spirit and scope of the technical solutions of the embodiments of this disclosure.

What is claimed is:

1. A method for playing media content, applied to an electronic device, comprising:
receiving data of a currently played television program sent by a smart television received from a broadcast television network; and
selecting media content matching the currently played television program from a local media library, and sending the media content to the smart television, so that the smart television plays the media content.

2. The method according to claim 1, further comprising:
after the media content, matching the currently played television program is selected, from the local media library, sending a request for playing the media content to the smart television; and
sending the media content to the smart television, in response to an operation of the smart television for requesting to receive the media content, so that the smart television plays the media content.

3. The method according to claim 1, wherein the data of the currently played television program comprises station information and/or image data of the currently played television program; and the selecting media content, matching the currently played television program, from a local media library comprises:
parsing the station information and/or the image data of the currently played television program to identify content of the currently played television program; and
selecting media content, same as or similar in content to the currently played television program as the media content matching the currently played television program, from the local media library.

4. A non-volatile computer storage medium storing computer executable instructions that, when executed by an electronic device, cause the electronic device to:
receive data of a currently played television program sent by a smart television received from a broadcast television network; and
select media content matching the currently played television program from a local media library, and send the media content to the smart television, so that the smart television plays the media content.

5. The non-volatile computer storage medium according to claim 4, wherein the electronic device is caused to:
after the media content matching the currently played television program is selected from the local media library, send a request for playing the media content to the smart television; and
send the media content to the smart television, in response to an operation of the smart television for requesting to receive the media content, so that the smart television plays the media content.

6. The non-volatile computer storage medium according to claim 4, wherein the data of the currently played television program comprises station information and/or image data of the currently played television program; and the instructions to select media content matching the currently played television program from a local media library cause the electronic device to:
parse the station information and/or the image data of the currently played television program to identify content of the currently played television program; and
select media content same as or similar in content to the currently played television program as the media content matching the currently played television program from the local media library.

7. An electronic device, comprising:
at least one processor; and
a memory communicably connected with the at least one processor for storing instructions executable by the at least one processor,
wherein execution of the instructions by the at least one processor causes the at least one processor to:
receive data of a currently played television program sent by a smart television received from a broadcast television network; and
select media content matching the currently played television program from a local media library, and send the media content to the smart television, so that the smart television plays the media content.

8. The electronic device according to claim 7, wherein the at least one processor is caused to:
after the media content matching the currently played television program is selected from the local media library, send a request for playing the media content to the smart television; and
send the media content to the smart television, in response to an operation of the smart television for requesting to receive the media content, so that the smart television plays the media content.

9. The electronic device according to claim 7, wherein the data of the currently played television program comprises station information and/or image data of the currently played television program; and the instructions to select media content matching the currently played television program from a local media library cause the electronic device to:
parse the station information and/or the image data of the currently played television program to identify content of the currently played television program; and
select media content same as or similar in content to the currently played television program as the media content matching the currently played television program from the local media library.
